(19) United States
(12) Patent Application Publication
(10) Pub. No.: US 2019/0376454 A1
(43) Pub. Date: Dec. 12, 2019

(54) ELECTRIC GEAR PUMP

(71) Applicant: Robert Bosch GmbH, Stuttgart (DE)

(72) Inventor: Nello MEDORO, Trinitapoli (IT)

(21) Appl. No.: 16/472,357

(22) PCT Filed: Dec. 14, 2017
(86) PCT No.: PCT/EP2017/082846

§ 371 Date: Jun. 21, 2019

(30) Foreign Application Priority Data
Dec. 21, 2016 (IT) 102016000129613

(51) Int. Cl. F02D 3/00; F04C 2/10

(52) U.S. Cl. CPC F02D 3/00; F04C 2210/203; F04C 2240/10; F04C 2/102

(57) ABSTRACT

An electric gear pump comprising a gerotor that may rotate about an axis of rotation A, comprising an external spur rotor and an internal spur rotor arranged outside the external spur rotor; a stator having electrical windings arranged outside the internal spur rotor; a surface covering coupled externally to the internal spur rotor; at least one magnet arranged between the internal spur rotor and the surface covering in such a way as to cause the gerotor to rotate when the electrical windings of the stator are supplied with current.

The present invention relates to an electric gear pump. In particular, the present invention relates to a gerotor electric gear pump.

The present invention also relates to a pump assembly comprising, in series:
a low-pressure pump (the abovementioned gerotor electric gear pump) for drawing fuel, preferably diesel, and for initial compression of the fuel; and p1 a high-pressure pump, preferably with pumping pistons, for further compression of the fuel and for supplying the fuel at high pressure to an internal combustion engine.

The use of systems for supplying fuel, in particular diesel, to an internal combustion engine, which comprise a high-pressure pump for supplying the internal combustion engine, and a low-pressure pump for supplying fuel to the high-pressure pump, is already known. The high-pressure pump comprises at least one pumping piston moved by a shaft and housed in a cylinder supplied with fuel at low pressure. At least two different types of low-pressure pump for such systems currently exist.

The first type comprises a gear pump which is driven by the same shaft as drives the pistons of the high-pressure pump. In particular, this gear pump may be a “gerotor” pump. As is known, the gerotor pump comprises an external spur rotor rotated by the shaft and housed inside an internal spur rotor. During rotation, the spurs of the external spur rotor engage with the spurs of the internal spur rotor, which has one more spur than the external spur rotor. The two rotors, rotating either absolutely or relatively, or relative to one another, pump fuel from an inlet, connected to the tank, to an outlet, connected to the high-pressure pump.

The second type of gear pump comprises gear pumps not driven by the shaft for driving the pumping pistons, but pumps driven electrically or electromagnetically. With this type of pump, in current gerotor pumps, at least one out of the internal spur rotor and the external spur rotor has magnetic or ferromagnetic modules, such as bundles of little plaques made of iron, which engage electromagnetically with a stator which is arranged outside of the internal spur rotor and comprises electrical windings. In particular, it is currently common to house the magnetic modules, which usually have a parallelepiped structure, embedded directly in the internal spur rotor near the external surface thereof, or near the windings of the stator placed outside the internal spur rotor.

By supplying current to said windings, electromagnetic conditions are created such that the gerotor starts to rotate, pumping the fuel between the tank and the high-pressure pump.

In this type of gerotor electric gear pump, the stator with electrical windings, which may also be defined as an “electric motor” since it causes the gerotor to move, is placed at the same level as said gerotor so as to increase the electromagnetic interaction. This concentric arrangement of gerotor and stator currently requires the presence of a bearing placed between the external wall of the internal spur rotor of the gerotor and the stator. A high degree of precision in terms of mechanical machining regarding the geometric circularity of the external surface of the internal spur rotor coupled to said bearing is thus necessary.

Although gerotor electric gear pumps are widely used, the current versions of these pumps have a number of drawbacks.

In particular, placing the magnets inside the internal spur rotor as described above is a difficult, expensive process.

In light of the known prior art, it is an aim of the present invention to produce an alternative gear pump, preferably an alternative gerotor electric gear pump.

In particular, it is an aim of the present invention to produce a gerotor electric gear pump which makes it possible to improve the corresponding prior art pumps described above, simply and economically, both from the functional viewpoint and from the structural viewpoint.

In accordance with these aims, the present invention relates to an electric gear pump comprising:
a gerotor that may rotate about an axis of rotation A, comprising an external spur rotor and an internal spur rotor arranged outside the external spur rotor;
a covering connected externally to the internal spur rotor;
a stator having electrical windings arranged outside the covering;
a magnetic structure arranged between the internal spur rotor and the covering and rigidly secured to the internal spur rotor in such a way as to cause the gerotor to rotate when the electrical windings of the stator are supplied with current.

Advantageously, in this way, the magnetic structure, which may take the form of one or more magnets or one or more ferromagnetic structures, is not embedded in the internal spur rotor but is rigidly secured thereto by being positioned between the external surface of the rotor and the covering thereof. As will be seen below, the magnetic structure may be held firmly in this position by providing direct connections between the magnetic structure and the covering and/or the rotor and it is even possible to provide for simply forcing the magnetic structure into position by compressing or clamping in seats.

According to a first embodiment of the invention, the magnetic structure is connected both to the covering and to the internal spur rotor. Preferably, according to this embodiment, both the covering and the magnetic structure are made in the form of cylindrical sleeves having the same height, along the axis of rotation A, as the external surface of the internal spur rotor. In this embodiment use is made of adhesive, both between the magnetic cylindrical sleeve and the covering and between the magnetic cylindrical sleeve and the internal spur rotor. According to this embodiment of the invention, the magnetic structure is therefore rigidly secured to the rotor by the connection provided by the adhesive, while the covering is connected to the rotor indirectly by means of the adhesive bonding to the magnetic structure which is in turn adhesively bonded to the rotor.

Advantageously, according to this embodiment, no particular machining of the surfaces of either the rotor or the covering is required.

According to another embodiment of the invention, the magnetic structure is connected to the covering or to the internal spur rotor. Preferably, the magnetic structure is connected to the covering or to the internal spur rotor by adhesive, while the covering is connected to the internal spur rotor by screws which are engaged in threaded holes made radially in the internal spur rotor. According to two different variants of this embodiment of the invention, the covering and the magnetic structure are made in the form of cylindrical sleeves provided with aligned holes, or the covering is made in the form of a cylindrical sleeve with holes and the magnetic structure is made in the form of magnetic sectors spaced apart in line with the holes in the covering. In this latter variant, lateral shoulders may be provided to facilitate positioning of the magnetic segments. According to this latter variant embodiment of the invention, the magnetic structure is rigidly secured to the rotor by virtue of the fact that it is connected to the covering, which is in turn connected to the rotor. Preferably, the screws used in the embodiments of the invention just described do not project outside the covering.

Advantageously, in this way, the screws do not have a negative impact on the rotary coupling between the covering and the bearing of the stator.

According to another embodiment of the invention, adhesive is not used and the magnetic structure is simply clamped in position by tightening the covering against the rotor. Preferably, according to a variant of this embodiment, the internal spur rotor comprises an external surface with at least one circumferential seat and the magnetic structure is made in the form of a ring clamped in the seat by the covering. Preferably, the covering of the rotor is made of metal, for example steel, so as to provide a functional surface for sliding on the bearing of the stator, which is usually made of plastic, for example PEEK.

Naturally, the present invention can be used both for a pump assembly for supplying fuel from a tank to an internal combustion engine which comprises, in series, an electric gear pump as described above and a high-pressure pump, and for just the internal spur rotor with the associated covering as a possible spare part that may be used to improve the pumps currently used.

Further features and advantages of the present invention will become clearer from the description below of two non-limiting embodiments thereof, with reference to the figures in the attached drawings, in which:

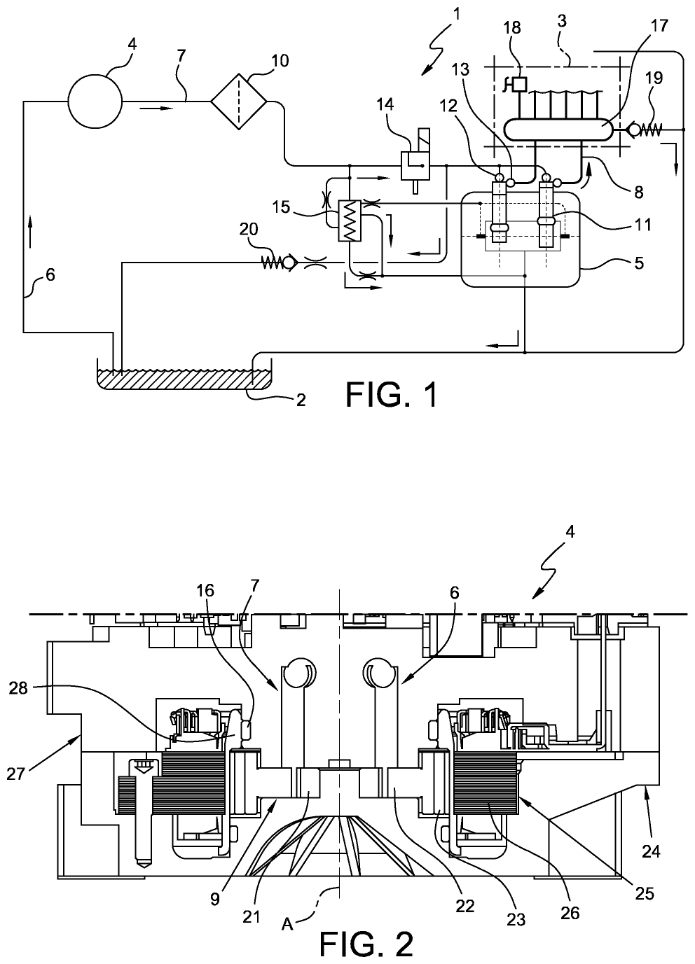

FIG. 1 is a schematic view of an embodiment of a pump assembly for supplying fuel, preferably diesel, from a tank to an internal combustion engine, which comprises, in series, a low-pressure gear pump and a high-pressure pump with pumping pistons;

FIG. 2 is a schematic view of a low-pressure gerotor gear pump according to the prior art;

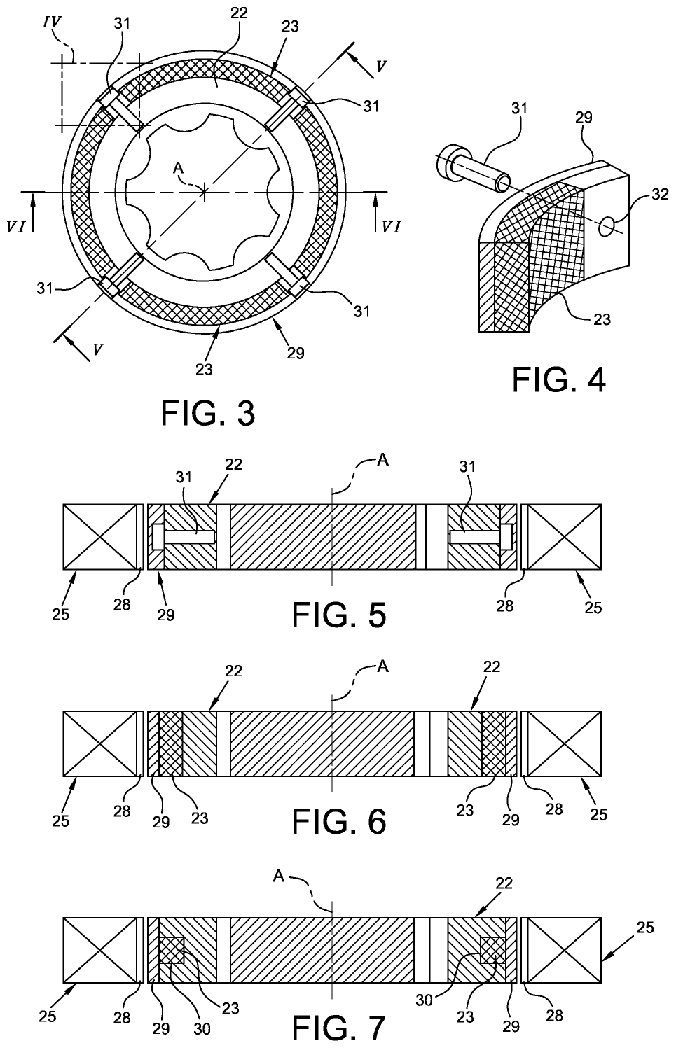

FIG. 3 is a schematic view along the axis of rotation of the gerotor in an embodiment of the present invention;

FIG. 4 is a partial enlarged schematic perspective view of the detail of FIG. 3 indicated by IV;

FIG. 5 is a schematic view in section of FIG. 3 along the section lines V-V;

FIG. 6 is a schematic view in section of FIG. 3 along the section lines VI-VI;

FIG. 7 shows another embodiment of the invention.

FIG. 1 is a schematic view of an embodiment of a pump assembly for supplying fuel, preferably diesel, from a tank to an internal combustion engine, which comprises, in series, a low-pressure pump and a high-pressure pump. In particular, FIG. 1 shows a pump assembly 1 comprising:
a low-pressure electric gear pump 4;
a high-pressure pump 5;
a low-pressure suction pipe 6 for supplying the fuel from the tank 2 to the electric gear pump 4;
a low-pressure delivery pipe 7 for supplying the fuel from the electric gear pump 4 to the high-pressure pump 5;
high-pressure delivery pipe 8 for supplying the fuel from the high-pressure pump 5 to the internal combustion engine 3.

In this example, the internal combustion engine 3 is shown only schematically and comprises a common manifold 17 fed by the high-pressure delivery pipes 8 and a plurality of injectors 18 (not shown) designed to spray and inject the fuel at high pressure into the cylinders of the internal combustion engine 3. In FIG. 1, the high-pressure pump 5 is shown only schematically and comprises two pumping pistons 11 supplied with fuel at low pressure at supply valves 12 and connected to delivery valves 13 for supplying the fuel at high pressure to the engine 3. FIG. 1 also shows a filter 10 arranged downstream of the low-pressure pump 4, a fuel measuring device 14 downstream of the filter 10, a relief valve 15 between the filter 10 and the fuel measuring device 14, a pressure limiting valve 19 connected to the manifold 17 and a valve 20 for delivering to the tank 2. The arrows shown in FIG. 1 indicate the path of the fuel through the pump assembly 1.

FIG. 2 shows a gerotor electric gear pump 4 according to the prior art. Said electric gear pump 4 comprises:
a gerotor 9 that may rotate about an axis of rotation A, comprising an external spur rotor 21 and an internal spur rotor 22 arranged outside the external spur rotor 21;
a stator 25 with electrical windings 26, arranged outside and at the same level as the gerotor 9;
a support base 24 for the gerotor 9;
a cover 27 that may be coupled to the base 24 in which the supply 6 and delivery 7 pipes are made at least partially;
a bearing 28, with associated seals 16, between the stator and the gerotor 9, in particular the external surface of the internal spur rotor 22.

As can be seen in FIG. 2, the internal spur rotor 22 has a magnetic structure 23 arranged near the bearing 28 so as to maximize the electromagnetic interaction with the windings 26 of the stator 25.

FIG. 3 is a schematic view along the axis of rotation A of an embodiment of the invention. In particular, according to this embodiment, the pump 4 comprises a covering 29, in the form of a cylindrical sleeve, preferably made of steel, coupled by screws 31 to the external surface of the internal spur rotor 22. A magnetic structure 23 in the form of magnetic sectors is clamped between said covering 29 and the internal spur rotor 22. By tightening the screws 31, the covering 29 is connected to the rotor 22 and, at the same time, the magnetic structure 23 is held in place. Said magnetic structure 23 may thus be rigidly secured to the rotor 22 simply by tightening the covering. However, the magnets 23 may be adhesively bonded to the covering 29 and/or the rotor 22. If adhesive is to be used both to couple the magnets 23 to the rotor 22 and to couple the magnets 23 to the covering 29, the screws 31 may even be dispensed with.

FIG. 4 is a partial enlarged schematic perspective view of the detail of FIG. 3 indicated by IV. Said figure shows the holes 32 made in the covering 29 for the passage of the screws 31 and the sectors 23 adhesively bonded to the covering beside the holes 32. As shown, preferably at the holes 32, the covering 29 has shoulders for lateral abutment of the magnetic sectors 23.

FIG. 5 is a schematic view in section of FIG. 3 along the section lines V-V. This figure shows how the screws 31 are designed not to project outside the covering 29 so as not to interfere with the bearing 28 of the stator 25 during rotation of the gerotor.

FIG. 6 is a schematic view in section of FIG. 3 along the section lines VI-VI. This figure shows, in section, that, according to the invention, the external periphery of the gerotor facing the stator is a multi-layer structure comprising, from the inside outwards, the internal spur rotor 22, the magnetic structure 23 and the covering 29 directly facing the bearing 28 of the stator 25.

FIG. 7 shows another embodiment of the invention in which the external surface of the internal spur rotor 22 comprises a seat 30, preferably a circumferential groove, for housing a magnetic structure 23 made in the form of a ring. According to this embodiment, the magnetic ring is clamped in position on one side by the seat 30 and externally by the covering 29. By selecting appropriate dimensions for the seat 30 it is possible to avoid the use of adhesive.

Lastly, it is clear that amendments and variations may be made to the invention described herein without exceeding the scope of the attached claims.

1. An electric gear pump (4) comprising:
a gerotor (9) configured to rotate about an axis of rotation (A), the gerotor comprising an external spur rotor (21) and an internal spur rotor (22) arranged outside the external spur rotor (21);
a covering (29) connected externally to the internal spur rotor (22);
a stator (25) having electrical windings (26) arranged outside the covering (29); and
a magnetic structure (23) arranged between the internal spur rotor (22) and the covering (29) and rigidly secured to the internal spur rotor (22) in such a way that the magnetic structure (23) causes the gerotor (9) to rotate when the electrical windings (26) of the stator (25) are supplied with electric current.

2. The pump as claimed in claim 1, in which the magnetic structure (23) is connected to the covering (29) and to the internal spur rotor (22).

3. The pump as claimed in claim 2, in which the covering (29) is in the form of a cylindrical sleeve and the magnetic structure (23) is in the form of a magnetic cylindrical sleeve, both of the sleeves having the same height as the internal spur rotor (22), adhesive being provided both between the magnetic cylindrical sleeve (23) and the covering and between the magnetic cylindrical sleeve (23) and the internal spur rotor (22).

4. The pump as claimed in claim 1, in which the magnetic structure (23) is connected to the covering (29) or to the internal spur rotor (22).

5. The pump as claimed in claim 4, in which the magnetic structure (23) is connected to the covering (29) or to the internal spur rotor (22) by adhesive, and the covering (29) is connected to the internal spur rotor (22) by screws (31).

6. The pump as claimed in claim 5, in which the covering (29) and the magnetic structure (23) are in the form of cylindrical sleeves provided with aligned holes.

7. The pump as claimed in claim 5, in which the screws (31) do not project outside the covering (29).

8. The pump as claimed in claim 1, in which the internal spur rotor (22) comprises an external surface with at least one seat (30) for the magnetic structure, the magnetic structure (23) being clamped in the seat by the covering (29).

9. The pump as claimed in claim 1, in which the covering (29) is made of metal.

10. A pump assembly for supplying fuel from a tank (2) to an internal combustion engine (3); the pump assembly (1) comprising an electric gear pump (4) according to claim 1 in series with a high-pressure pump (5); in which the electric gear pump (4) is a low-pressure electric gear pump.

11. The pump as claimed in claim 5, in which the covering (29) is in the form of a cylindrical sleeve with holes (32) and the magnetic structure (23) is in the form of magnetic sectors spaced apart in line with the holes (32) in the covering (29).
